(19) United States
(12) Patent Application Publication
(10) Pub. No.: US 2021/0182785 A1
(43) Pub. Date: Jun. 17, 2021

(54) APPARATUS FOR SECURE DELIVERY OF A PACKAGE

(71) Applicant: Michael Anburaj, Mountain House, CA (US)

(72) Inventor: Michael Anburaj, Mountain House, CA (US)

(21) Appl. No.: 17/169,125

(22) Filed: Feb. 5, 2021

Related U.S. Application Data
(60) Provisional application No. 62/977,396, filed on Feb. 16, 2020.

(51) Int. Cl. G06Q 10/08; H04L 29/06; G07C 9/00; G06K 7/14; G06K 7/10; G06F 1/20

(52) U.S. Cl. CPC G06Q 10/0836; H04L 63/0869; G07C 9/00912; G06F 1/206; G06K 7/1417; G06K 7/10297; G06K 7/1413

(57) ABSTRACT

An apparatus for authenticating a package delivery in absence of a recipient. The apparatus includes a frame that can be mounted to ground or an upstanding structure. One or more enclosures and a control unit encased in the frame. Each one or more enclosures having a digital lock operably coupled to the control unit. The enclosures can be reserved for package delivery, wherein the control unit can receive a configuration file from a user device and reserves the enclosure for the package delivery on a predefined date and duration. The control unit can receive and verify the delivery request from a service provider's device for the package delivery. The control unit can verify and authenticate the delivery request based on the configuration instruction and accordingly unlock the enclosure for the package delivery.

### CROSS-REFERENCE TO RELATED APPLICATIONS

This application claims priority to the U.S. provisional patent application Ser. No. 62/977,396 filed on Feb. 16, 2020, which is incorporated herein by reference in its entirety.

### FIELD OF INVENTION

The present invention relates to an apparatus for secure delivery of a package, and in more particular, the present invention relates to an apparatus for safely and securely receiving and stowing of a delivery package.

### BACKGROUND

The Courier industry has been booming in the last decade. E-commerce and home-delivery of goods are one of the major factors behind the exponential increase in the courier industry. However, there have also increased the incidents of thefts and lost packages. The prime concern for the majority portion of the courier industry is the secure delivery of the packages.

The courier companies have developed methods for remotely authenticating the delivery of packages. A live video feed of the delivery of the package can be monitored remotely by an official of a service provider or any agent thereof. Although, said remote authentication method can ensure the secure delivery of a package, the method has several drawbacks. First, the method requires a recipient taking the delivery of the package and the remote official to remotely monitor the live feed. Deliveries of a package directly to a recipient can be problematic for several reasons, such as a recipient may not be available to take the delivery. That may require the delivery person to come again at a different time or cancel the delivery. Second, the cost of human intervention, cameras, and cellular network data expenses can be huge, thus making the method costly. Third, the imposters can still break the remote visual authentication easily. The known methods for remote authentication of delivery of packages lack support for multiple independent deliveries from different shipping carriers.

Considering the rise in package deliveries in recent years and also the increasing incident of thefts and lost packages, an urgent need is there for an improved apparatus for safe and secure delivery of the packages.

The term “package” is used herein to describe any type of package, parcel, bag, or items. The items may be loose or packed. The items include ordered items being delivered to the consumer's address. The items include food items, groceries, household items, office supplies, pharmaceuticals, newspaper, and like items that can be delivered to the consumer's address.

The term “delivery package” is used herein to describe the package that is being delivered to a recipient.

The terms “recipient”, “user”, or “consumer” are interchangeably used to describe a person authorized to receive a delivery package and includes a person who has ordered the package for delivery to his/her address, an agent of the person or relatives of the person ordering the package.

The term “address” is used to describe a place at which a package has to be delivered and includes residential and commercial places.

The term “deliveries” is used herein to describe a package that is to be delivered or is delivered to the recipient's address.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an apparatus for safe and secure delivery of packages.

It is an additional object of the present invention that the apparatus provides for unattended receipt of delivery packages.

It is still an additional object of the present invention that the apparatus provides for safe storage of the delivery package.

It is yet another object of the present invention that the apparatus provides for unmanned authentication of the delivery of the package.

It is still a further object of the present invention that the apparatus prevents theft of the delivery package.

It is also an object of the present invention that the apparatus provides a safeguard against imposters in the package delivery.

In one aspect, the present invention is directed to an apparatus for safe and secure delivery of a package to a destined address without a need for human presence to receive and confirm the delivery. The disclosed apparatus comprises a frame configured to be installed on the ground or mounted to an upstanding structure, one or more enclosures configured in the frame, and a control unit operably coupled to the one or more enclosures. The access to one of more enclosures can be secured by a digital lock, wherein the digital lock can be operated by the control unit for locking and unlocking the digital lock. The enclosure can be a shelf with a door or a drawer both secured by the digital lock. The control unit can include network circuitry for receiving configuration instruction from a user device and optionally, sending a notification to the user device. The network circuitry may also allow communicating with a central authentication & Management server (CAMS), service provider which can be a courier company. The control unit can parse the configuration instructions to select one or more enclosures based on the configuration instruction. The control unit can receive a delivery request from a service provider's device and can open one or more enclosures based on the configuration instruction and the delivery request. The delivery request can be received through a network, directly by reading RF tags on the package or on the service provider's device. The delivery request can also be sent through a secure server, for example, the service provider or the service provider's device can send the delivery request through the central authentication & Management server (CAMS) for additional security.

In one aspect, the user device can be connected to the control unit of the apparatus through a network. Similarly, the control unit can receive the delivery request from a service provider's device through a communication network. The user device, the control unit, and the service provider's device can be connected to an authentication server that authenticates the user device, the control unit, and the service provider's device for communicating with each other.

These and other objects and advantages of the embodiments herein will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a perspective view of the apparatus for secure delivery of a package, according to an exemplary embodiment of the present invention.

FIG. 2 is an environmental diagram showing the user device, the disclosed apparatus, and the service provider's device, according to an exemplary embodiment of the present invention.

FIG. 3 is a flow chart showing the delivery of a package using the disclosed apparatus, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, the reasonably broad scope for claimed or covered subject matter is intended. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe embodiments only and is not intended to be limiting of embodiments of the invention. As used herein, the singular forms “a”, “an” and “the” are intended to include the plural forms as well, unless the context indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention since the scope of the invention will be best defined by the allowed claims of any resulting patent.

The following detailed description is described with reference to the drawings, wherein like reference numerals are used to refer to like elements throughout. In the following description, for purposes of explanation, specific details may be outlined to provide a thorough understanding of the subject innovation. It may be evident, however, that the claimed subject matter may be practiced without these specific details. In other instances, well-known structures and devices are shown in block diagram form to facilitate describing the subject innovation. Moreover, the drawings may not be to scale.

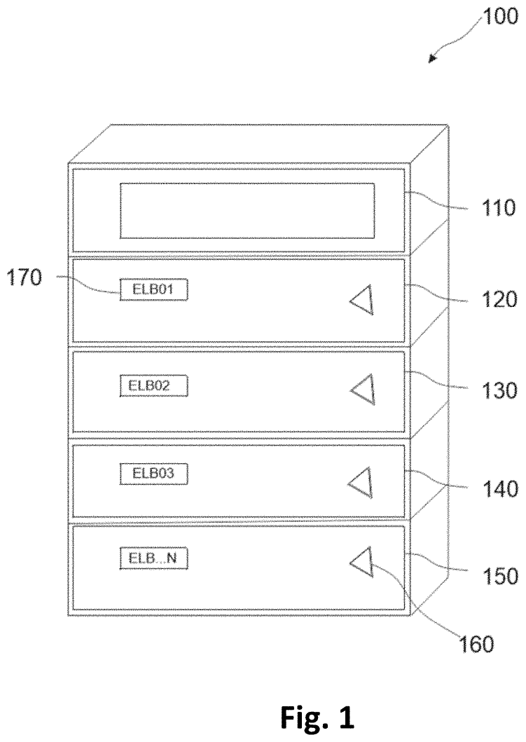

Now referring to FIG. 1 which shows an embodiment of the disclosed apparatus for safe and secure delivery of package. The apparatus 100 can provide for unmanned receipt of a delivery package. Moreover, the delivery of the package can be authenticated in the absence of the recipient. Advantageously, the authentication can be automated, thus saving manpower, time, and cost. The disclosed apparatus provides a safe and secure method of delivering a package to a destined address, wherein the delivery package is stored safely in a locked enclosure of the apparatus 100. FIG. 1 shows the apparatus 100 having a frame 110 that can be installed on the ground or mounted to an upstanding structure. The disclosed frame 100 can also be suspended on a fixed structure. For example, the disclosed apparatus 100 can be installed in front of a building or mounted to a front wall of the building. The apparatus can also be installed in the reception area of the building. The building can be a house or a multi-family residential. Also, the building can be a commercial place, such as an office or multiple offices in a building. As shown in FIG. 1 the apparatus 100 can include multiple enclosures 120-150 that can be stacked vertically or horizontally. The disclosed apparatus 100 can include one or more enclosures for receiving and storing a delivery package. The enclosure can be shelves or drawers. For example, the frame can be divided by walls to form the enclosures. Alternatively, enclosures can be installed in the frame. Similar, drawers can be installed in the frame. The apparatus can include one or more shelves, drawers, or a combination of the shelves and drawers. In the case of shelves, the shelves can have a door pivotally coupled to the enclosure. The enclosures can be added or removed from the stack of enclosures. Moreover, the enclosures of different dimensions can be added. Suitable expansion slots may be provided in the frame that may allow adding the enclosures of the same or different sizes, including connecting the enclosures to the control unit and sensors. One or more enclosures can also be temperature regulated. For example, the enclosure having a small refrigeration unit and heating unit to keep the temperature within the enclosure within a desired temperature range. The walls of the enclosure can be insulated to save energy.

The door of shelves or the drawers can be secured with digital/electronic locks. The enclosures and frame of the disclosed apparatus can be made of any strong material, such as steel, and secured by a tamper proof harness. The drawer or the door of the shelve can have a handle 160 to pull the drawer or the door. Moreover, each enclosure can be assigned a unique id, which can be temporary or permanent. The unique id can be an address of the enclosure to which a package can be addressed and delivered. For example, such an apparatus 100 can be provided in a public place, and at the address of an enclosure, a delivery package can be received by the disclosed apparatus 100.

The address or unique id of each enclosure can be displayed on the front of the enclosure i.e., on the door or front wall of a drawer. The address can be printed on the surface of the door or drawer. Alternatively, a display panel 170 can be provided for each enclosure of the apparatus that displays the unique id of the enclosure. The display can be useful when temporary IDs are assigned to the enclosure. It is to be understood that FIG. 1 shows a single column of vertically stacked enclosures, however, any number of enclosures in any arrangement is within the scope of the present invention. For example, two columns of vertically stacked enclosures or a single enclosure both are within the scope of the present invention. The shape and size of the enclosures can be varied without departing from the scope of the present invention. Two or more enclosures can have a common divider that allows merging them in a single and bigger enclosure. For example, between the enclosures there may be swinging door with locking tabs, removable sheet or similar mechanism for consolidating the enclosures to take large size package.

FIG. 1 shows a control unit 180 on top of the apparatus 100 also enclosed in the frame 110. The control unit can include a processor and a memory, like a computing unit. The control unit can include software stored in the memory which on execution by the processor allows operating the disclosed apparatus. The control unit can be coupled to one or more enclosures of the apparatus. The control unit can be configured to open and close the door of the enclosures or slide in and out of the drawers. The control can be operably coupled to the digital locks of each enclosure for locking and unlocking the digital locks. Suitable indicators or display panels can also be included in the enclosure, wherein the indicators or display panel can be displayed in front of the enclosure. The indicators can be visual indicators that show the status of the enclosure, such as the enclosure is locked, unlocked, or includes a delivery package. The same can also be presented through a display panel. Both the indicators and the display panel can be connected to the control unit. Moreover, all the enclosures of the apparatus can be controlled by a single control unit. The number of enclosures can be increased or decreased at any time, as desired. Moreover, the enclosures in a single apparatus can be assigned to different persons.

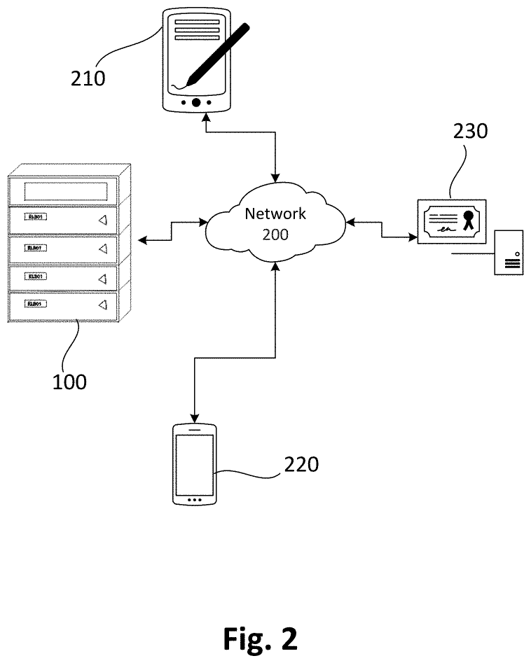

FIG. 2 shows the apparatus 100 connected to a user device 210 through a network 200. The network can be wired or wireless. For example, apparatus 100 can be connected to a user device 210 through a wire. The control unit 180 can include a network circuitry that can connect to the user device 210 through a wired or wireless connection. The network 200 can be a cellular communication network, LTE, UMTS, WiMAX, EV-DO, CDMA, GSM, Bluetooth, Bluetooth Low Energy, Bluetooth Smart, Wireless Fidelity (Wi-Fi), Zigbee, ANT, ANT+, Thread, Internet Protocol (IP), Ethernet, Fast Ethernet, Gigabit Ethernet, power line communication, ATM, FDDI, Near Field Communication (NFC), or any other network known to a skilled person for sharing data packets between two electronic devices. In one case, the network can be a cloud network.

The user device 210 can receive notifications from the control unit 180 and can send instructions to the control unit 180. The user device can be a computing device, such as laptop, desktop, workstation, tablet computer, smartphone, and like. The user device can also include application software that allows the user device to communicate with the disclosed apparatus. The application software may provide one or more interfaces for a user to send instructions to the apparatus and receive notifications from the apparatus. The application software can be developed for different platforms, such as Windows, Android, and iOS. Alternatively, one or more interfaces can be provided as a web interface that can be accessed on a user device through web browsers.

The disclosed apparatus 100 provides the ability for the recipient to pre-associate anticipated package credentials to the apparatus and to provide electronic authentication & package credentials verification at the time of package delivery. This frees-up human availability at the time of package delivery & provide superior authentication & security.

The control unit can receive package authentication credentials for each enclosure and associate the said package authentication credentials to the enclosures. The package authentication credentials can be received through the user device. At least one interface on the user device provided by the disclosed application software can be an administrative control interface that can help to set-up the disclosed apparatus for secure package delivery and authentication of the deliveries. The administrative control interface can send the configuration instructions, having the package authentication credentials, to the control unit which can then select one or more enclosures based on parsing of the configuration instructions. The selected one or more enclosures can be then reserved for the scheduled delivery. The configuration instructions can also be received through a secure third-party server, such as a central authentication & Management server (CAMS).

In one exemplary embodiment, the configuration instruction can have a structure and syntax for providing sending different parameters to the control unit. An exemplary embodiment of the configuration file is as below:

[Carrier#|Carrier-deviceID#|Package#|PackageAttributes-Size-andOther#|DeliveryDate-Window#|Deliverytime-Window#]

The user device 210, control unit 180, or CAMS 230 can receive the details of delivery from the courier company or the service provider. Such details can include the Carrier#|Carrier-deviceID#. The Carrier-deviceID# can be a combination of, not limited to, and maybe a subset of IPv6-address-range, EUI64-block of address, mobile no, or mobile-device serial number, and like. The details can also include Package#|PackageAttributes-Size-andOther#, the package size, and optionally weight. The other information can include TemperatureRequirement# i.e., the temperature requirement of the package for storage. The other information can also include PackageAttributes-SecurityLevel# i.e., the degree of security required for storage. For example, few precious items may need stronger security than food items. The syntax of the configuration file can include additional parameters to accommodate the needs of different users in the present or future.

The user device 210, control unit 180, or CAMS 230 can also receive the details of the scheduled delivery of the package, such as the date and expected time of delivery. The service provider can send a date and time window in which the delivery can be made. The application software on the user device can process the details received from the service provider to generate the configuration instruction. The configuration instruction can then be sent to the control unit through the network.

The control unit can receive the configuration instruction from the user device, CAMS, or the service provider, and process the same for selecting one or more enclosures. For example, the control unit can select the desired enclosure based on the size of the package. For example, the enclosure that can receive the package size provided in the configuration file can be reserved for delivery by the control unit of the disclosed apparatus. Alternatively, the control unit can also receive a unique id of the user device through which the configuration file is received. Such a unique id can also be used for the authentication of the user device. Upon successful authentication, the enclosure pre-associated with the user device can be reserved for the scheduled delivery. Since the enclosure may be available in different dimensions, the control unit can reserve an enclosure based on the Package#|PackageAttributes-Size-andOther#. In case, the Package#|PackageAttributes-Size-andOther# also includes temperature details, the enclosure with temperature control can also be selected.

The reservation of the enclosure is such that the enclosure can be unlocked only in the DeliveryDate-Window# and during the Deliverytime-Window# and only by the Carrier#|Carrier-deviceID#. An attempt to open the enclosure by a carrier device other than the Carrier#|Carrier-deviceID# may be denied by the disclosed control unit. Moreover, any attempt to unlock the enclosure by the Carrier#|Carrier-deviceID# outside the DeliveryDate-Window# or the Deliverytime-Window# can also be denied by the system. The control unit can also provide a counter variable, which can be appended to the configuration file. The counter variable can keep track of the number of delivery attempts, such as connection attempts of the service provider's device with the control unit and upload of delivery requests.

The disclosed control unit can include one or more sensors to scan the attributes of the delivery package at the time of delivery. Such attributes can include the size of the package and/or weight of the package. The disclosed apparatus may also include optical sensors to take a photograph of the delivery package. Additionally, the disclosed apparatus can also include readers to scan barcodes, QR codes, and like RF tags on the package. The said attributes of the package can be used to verify that a correct package is being delivered. For example, the attributes package-size can be matched with the Package#|PackageAttributes-Size-andOther# in the configuration instruction. In case of any mismatch between the Package#|PackageAttributes-Size-andOther# and the scanned package attributes, a warning/error can be displayed to the delivery person or on the service provider's device. Also, a notification can be sent to the user's device. A photograph of the product being captured at the time of delivery can be used as evidence for the tampered package.

In one exemplary embodiment, the control unit can use the value of the parameters Carrier#|Carrier-deviceID# in the configuration instruction for the authentication of the service provider's device. The value of Carrier#|Carrier-deviceID# can be received from the delivery person at the time of delivery. Also, can be received is the GPS location of the disclosed apparatus. The apparatus can include an input/output device for interacting with the service provider's device. The service provider's device can be a laptop, desktop, workstation, tablet computer, smartphone, and like. The service provider's device can also include application software that allows the service provider's device to communicate with the disclosed apparatus. The application software may provide one or more interfaces for a delivery person to send a delivery request to the apparatus. The application software can be developed for different platforms, such as Windows, Android, and iOS. Alternatively, one or more interfaces can be provided as a web interface that can be accessed on a user device through web browsers.

The apparatus can include input/output means to receive a delivery request from the service provider's device. FIG. 2 shows the service provider's device 220, which can be a smartphone that can be connected to the apparatus 100 through a network 200. It is to be understood that FIG. 2 shows the same network 200 connecting the control unit 100, user device 210, the service provider's device 220, and a central authentication & Management server (CAMS) 230 for illustration only, however, a skilled person will understand that the user device 210, the service provider's device 220, and the server 230 can be connected through different networks.

Preferably, the service provider's device can be connected to the apparatus through a short-range communication network, such as Bluetooth, Wi-Fi, NFC, and like. Such communication can be one-way communication from the service provider's device to the apparatus or two-way communication. Alternatively, the apparatus can include scanners, such as RF scanners that can read a QR tag or a similar tag on the service provider's device to read the delivery request. Still, alternatively, the delivery person can have hard tags that can be scanned by the scanners coupled to the control unit of the disclosed apparatus. The delivery request can at least include the Carrier#|Carrier-deviceID#. The delivery request can include additional parameters for authentication of the delivery. An exemplary embodiment of the delivery request is given below:

[Carrier#|Carrier-deviceID#|Package#|PackageAttributes-Size-andOther#|DeliveryDate-Instance#|Deliverytime-Instance#|Additional-Parameters#]. The Additional-Parameters# may include but not be limited to Per Package-User Shared-Passcode# that can be secretly shared between the carrier and the User. The passcode can also be manually entered by the delivery person using a keypad provided on the apparatus. Additional-Parameters# may also include Agent-Biometric# of the delivery agent. Additional-Parameters# may also include the GPS-Location# of the apparatus that can be validated by the control unit to ensure the correct delivery address. The delivery request may also include the counter-variable#, the value of which can be allowed connection attempts between the service provider's device and the control unit.

The disclosed apparatus may require an additional layer of security. An authentication server, such as central authentication & Management server (CAMS) 230, can authenticate the apparatus 100, the user device 210, and the service provider's device 220, such as they can connect securely. The authentication and connections can be secured based on known security protocols, such as TLS, SSL, IPSec, or EAP. The certificates can be generated based on hardware-level security and other parameters, such as [Product-UniqueID#|Serial#|GPS-Location#|Router-Location#]. The CAMS can periodically do (large number of) key refresh, keys/certificates used for both authentication & data security. CAMS also Authenticate the service provider's device & periodically perform key/certificate refresh. All of the communication between the service provider's device and the control unit can be independently carried out using Secure and authenticated communication channels defined by not limited to TLS, SSL, IPsec, or EAP. Using the information synced by the CAMS, now the service provider's device and the control unit can perform a 2-way mutual authentication of each other before exchanging the delivery request using secure communication channel.

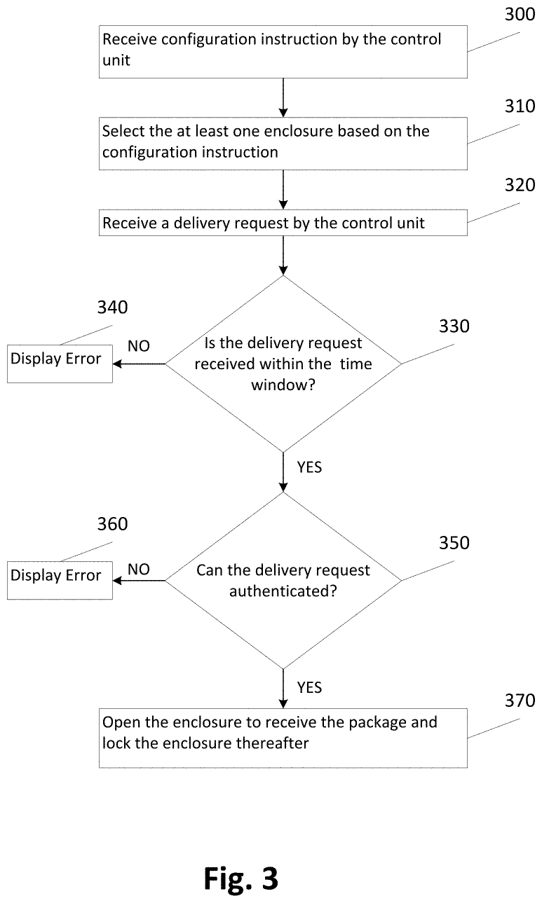

Referring to FIG. 3, which shows a method of delivery of a package using the disclosed apparatus. At step 300, the control unit of the disclosed apparatus can receive a configuration instruction from a user device, control unit, or CAMS. The control unit can parse the configuration instruction to select one or more enclosure of the apparatus, and the selected one or more enclosures can be reserved for delivery, at step 310. At the time of delivery, the control unit can receive a delivery request from the service provider's device, by reading tags directly from the package, courier company or the service provider through CAMS, at step 320. The control unit can check at step 330 if the delivery request is received within the predefined date and time window i.e., the value of the variables DeliveryDate-Window#|Deliverytime-Window# in the configuration file. The delivery request can include the values DeliveryDate-Instance#|Deliverytime-Instance#, which can be matched with the DeliveryDate-Window#|Deliverytime-Window#. In case, the outcome is negative at step 330, i.e., the delivery request is received outside the pre-set date and time window, the control unit can display an error, at step 340. In case, the delivery request is received within the DeliveryDate-Window#|Deliverytime-Window#, the control unit can further verify the delivery request, at step 350. If the delivery request could not be verified by the control unit, an error can be generated by the control unit, at step 360. If the delivery request is also verified, at step 350, the control unit can unlock the enclosure, at step 370.

In one case, when the configuration file is [Carrier#|Carrier-deviceID#|Package#|PackageAttributes-Size-andOther#|DeliveryDate-Window#|Deliverytime-Window#]; and the delivery request is [Carrier#|Carrier-deviceID#|Package#|PackageAttributes-Size-andOther#|DeliveryDate-Instance#|Deliverytime-Instance#|Additional-Parameters#], the control unit can match the delivery request by comparing the matching the delivery request against the configuration instruction.

The delivery according to the present invention can be made by a delivery person, robots, drones, and like methods for delivery of a package. The deliveries can be made any time, for example in night, without requiring the presence of humans or recipient. The disclosed apparatus can also be used for 1. Provisions delivery, 2. Office lunch box delivery systems, 3. Food ordering/pick-up boxes, 4. Locker room boxes 5. Remote vending machines, 6. Bank security lockers, 7. Secure Document repositories. And any other application that needs remotely managed security boxes with authentication.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An apparatus for authenticating a package delivery, the apparatus comprising:
a frame that can be mounted to ground or an upstanding structure;
at least one enclosure encased in the frame, the at least one enclosure having an opening for gaining access to an interior of the at least one enclosure, the at least one enclosure configured to switch between a lock state and a unlock state, in the unlock state the opening is accessible, and in the lock state the opening is inaccessible;
a control unit encased in the frame; and
a digital lock operably coupled to the control unit, the digital lock secures the switching of the at least one enclosure from the lock state to the unlocked state,
wherein the control unit is configured to:
receive a configuration instruction, the configuration instruction is having a plurality of variables that are structured according to a predefined syntax, the plurality of variables comprises a carrier, carrier device id, delivery date window, delivery time window, and package attributes, and
reserving the at least one enclosure based on the configuration instruction for the package delivery.

2. The apparatus according to claim 1, wherein the apparatus comprises a plurality of enclosures of different sizes, the package attributes includes a package size, the control unit reserves one or more enclosures of the plurality of enclosures based on the package size.

3. The apparatus according to claim 1, wherein the apparatus further comprises a plurality of enclosures, the control unit reserves one or more enclosures of the plurality of enclosures based on the package attributes, the delivery date window, and the delivery time window.

4. The apparatus according to claim 1, wherein the control unit is configured to unlock the at least one enclosure during the delivery date window and the delivery time window.

5. The apparatus according to claim 1, wherein the control unit further comprising a network circuitry for connecting to a user device, the configuration instruction is received from the user device, the user device and the control unit authenticates each other through a central authentication & Management server (CAMS) and connect over a secure connection.

6. The apparatus according to claim 5, wherein the control unit is further configured to:
receive a delivery request from a service provider's device or the package for package delivery,
verify the receipt of the delivery request to be within the delivery date window and the delivery time,
upon the verification, match the delivery request with the configuration file for authentication, and
upon authentication, switch the at least one enclosure to the unlock state.

7. The apparatus according to claim 6, wherein the control unit is further configured to:
upon switching, verifying the package based on the package attributes.

8. The apparatus according to claim 6, wherein the service provider's device is authenticated by the central authentication & Management server (CAMS) for securely connecting with the control unit.

9. The apparatus according to claim 1, wherein the frame comprises expansion slots for installing one or more additional enclosure of same or different dimensions, the one or more additional enclosure connects to the control unit.

10. The apparatus according to claim 1, wherein one of the plurality of enclosures comprises a temperature-controlled enclosure, and the package attributes includes the temperature requirement for the delivery package.

11. The apparatus according to claim 6, wherein the control unit includes a RF scanner or a QR barcode reader configured to read a QR code or barcode or an RFID tag for receiving the delivery request.

12. The apparatus according to claim 11, wherein the QR code or the barcode or the RFID tag is provided on the package.

13. A method for secure package delivery that does not require presence of recipient for authentication, the method comprises the steps of:
providing an apparatus comprising:
a frame that can be mounted to ground or an upstanding structure;
at least one enclosure encased in the frame, the at least one enclosure having an opening for gaining access to an interior of the at least one enclosure, the at least one enclosure configured to switch between a lock state and a unlock state, in the unlock state the opening is accessible, and in the lock state the opening is inaccessible;
a control unit encased in the frame; and
a digital lock operably coupled to the control unit, the digital lock secures the switching of the at least one enclosure from the lock state to the unlocked state,
wherein the control unit is configured to:
receive a configuration instruction, the configuration instruction is having a plurality of variables that are structured according to a predefined syntax, the plurality of variables comprises a carrier, carrier device id, delivery date window, delivery time window, and package attributes,
reserving the at least one enclosure based on the configuration instruction for the package delivery,
receiving a delivery request from a service provider's device, and
upon verification of the delivery request, operating the reserved enclosure to the unlock state;
receiving, by the control unit, the configuration file from a user device;
reserving, by the control unit, at least one enclosure based on the configuration instruction, the reservation based on at least the package attributes;
upon reservation of the at least one enclosure, receiving a delivery request from a service provider's device;
verifying the date and time of the delivery request with the delivery date window and the delivery time window in the configurate instruction; and
upon successful verification of the date and time, varying the delivery request by matching with the configuration instruction.

14. The method according to claim 13, wherein the apparatus comprises a plurality of enclosures of different sizes, the package attributes includes a package size, the control unit reserves one or more enclosures of the plurality of enclosures based on the package size.

15. The method according to claim 14, wherein the plurality of enclosures includes a temperature-controlled enclosure, and the package attributes includes the temperature requirement for the package.

16. A method for secure package delivery that does not require presence of recipient for authentication, the method comprises the steps of:
providing an apparatus comprising:
a frame that can be mounted to ground or an upstanding structure;
at least one enclosure encased in the frame, the at least one enclosure having an opening for gaining access to an interior of the at least one enclosure, the at least one enclosure configured to switch between a lock state and a unlock state, in the unlock state the opening is accessible, and in the lock state the opening is inaccessible;
a control unit encased in the frame; and
a digital lock operably coupled to the control unit, the digital lock secures the switching of the at least one enclosure from the lock state to the unlocked state,
wherein the control unit is configured to:
receive a configuration instruction, the configuration instruction is having a plurality of variables that are structured according to a predefined syntax, the plurality of variables comprises a carrier, carrier device id, delivery date window, delivery time window, and package attributes,
reserving the at least one enclosure based on the configuration instruction for the package delivery,
receiving a delivery request, and
upon verification of the delivery request, operating the reserved enclosure to the unlock state;
receiving, by the control unit, the configuration file;
reserving, by the control unit, at least one enclosure based on the configuration instruction, the reservation based on at least the package attributes;
upon reservation of the at least one enclosure, receiving a delivery request;
verifying the date and time of the delivery request with the delivery date window and the delivery time window in the configurate instruction; and
upon successful verification of the date and time, varying the delivery request by matching with the configuration instruction.

17. The method according to claim 16, wherein the configuration instruction is received from a central authentication & Management server (CAMS).

18. The method according to claim 17, wherein the delivery request is received from a service provider or a courier company through the central authentication & Management server (CAMS).

19. The method according to claim 17, wherein the delivery request is read from a QR tag, RFID tag, or a bar code from the delivery package.
